(19) United States
(12) Patent Application Publication
(10) Pub. No.: US 2026/0179050 A1
(43) Pub. Date: Jun. 25, 2026

(54) APPARATUSES, SYSTEMS, AND COMPUTER PROGRAM PRODUCTS FOR FACILITATING MULTI-TENANT ENTERPRISE MESSAGING INTEGRATIONS VIA A TENANT MAPPING AND PROVISIONING SYSTEM

(71) Applicant: Atlassian PTY Ltd, Sydney (AU)

(72) Inventors: Aneesh KUNDU, Delhi (IN); Murigipudi REVANTH, Nellore (IN); Piyush KUMAR, Bangalore (IN); Drishika JAIN, Lucknow (IN)

(21) Appl. No.: 19/001,043

(22) Filed: Dec. 24, 2024

(51) Int. Cl. G06Q 10/107; G06F 21/31; G06Q 10/101

(52) U.S. Cl. CPC G06Q 10/107; G06F 21/31; G06Q 10/101

(57) ABSTRACT

A tenant mapping and provisioning apparatus that is configured for operation between a multi-tenant incident management system and a multi-tenant messaging system to access an active incident management tenant of the multi-tenant incident management system, identify a candidate set of messaging system tenants, generate an authenticated association between the active incident management tenant and a selected messaging system tenant of the candidate set of messaging system tenants, wherein the selected messaging system tenant defines at least one established authenticated association with another incident management tenant of the multi-tenant management system, generate an incident messaging data object based on an incident event data managed by the active incident management tenant, and output the incident messaging data object to the selected messaging system tenant, wherein the incident messaging data object is configured to cause rendering of an incident event interface component to a messaging interface of the selected messaging system tenant.

### BACKGROUND

Enterprise messaging tools provide digital forms of real-time, conversation-driven collaboration. Incident management tools are configured to manage and triage alerts and incidents that occur in software platforms. New methods for enabling efficient integration between enterprise messaging tools and incident management tools are needed. The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

In one aspect, a tenant mapping and provisioning apparatus is configured for operation between a multi-tenant incident management system and a multi-tenant messaging system, wherein the tenant mapping and provisioning apparatus comprises one or more processors and one or more memories storing instructions that are operable, when executed by the one or more processors, to cause the tenant mapping and provisioning apparatus to: access an active incident management tenant of the multi-tenant incident management system, wherein the active incident management tenant is associated with an active user profile; identify a candidate set of messaging system tenants of the multi-tenant messaging system, wherein the candidate set of messaging system tenants are each respectively associated with the active user profile; generate an authenticated association between the active incident management tenant and a selected messaging system tenant of the candidate set of messaging system tenants, wherein the selected messaging system tenant defines at least one established authenticated association with another incident management tenant of the multi-tenant management system; generate an incident messaging data object based on an incident event data managed by the active incident management tenant; and output the incident messaging data object to the selected messaging system tenant of the multi-tenant messaging system, wherein the incident messaging data object is configured to cause rendering of an incident event interface component to a messaging interface of the selected messaging system tenant of the multi-tenant messaging system.

The tenant mapping and provisioning apparatus is further configured to: receive, from the selected messaging system tenant of the multi-tenant messaging system, incident event data comprising an indication of an incident messaging action; determine a correct incident management tenant of the multi-tenant incident management system for transmission of the incident event data; output the incident event data to the correct incident management tenant of the multi-tenant incident management system; receive, from the correct incident management tenant, updated incident event data comprising an indication of an incident update based on the incident messaging action; generate an updated incident messaging data object based on the updated incident event data managed by the correct incident management tenant; determine a correct selected messaging system tenant of the multi-tenant messaging system for transmission of the updated incident messaging data object; and output the updated incident messaging data object to the correct selected messaging system tenant of the multi-tenant messaging system, wherein the updated incident messaging data object is configured to cause rendering of an incident event interface component to a messaging interface of the correct selected messaging system tenant of the multi-tenant messaging system.

The tenant mapping and provisioning apparatus further includes where the active incident management tenant has an authenticated association with a plurality of selected messaging system tenants.

The tenant mapping and provisioning apparatus further includes where the selected messaging system tenant has an authenticated association with a plurality of incident management tenants.

The tenant mapping and provisioning apparatus is further configured to: request, prior to generation of the authenticated association between an active incident management tenant and a selected messaging system tenant, permission to access the selected messaging system tenant.

The tenant mapping and provisioning apparatus is further configured to: determine, when a plurality of selected messaging system tenants have an authenticated association with the active incident management tenant, a correct selected messaging system tenant for transmission of the incident messaging data object.

The tenant mapping and provisioning apparatus is further configured to: receive, from an incoming event queue, event data; cause, based at least in part on the event data, generation of an incident; and generate an authenticated association between the incident and an incident management tenant.

In one aspect, a computer program product includes at least one non-transitory computer-readable storage medium having computer readable program code portions stored therein, the computer-readable program code portions configured to: access an active incident management tenant of the multi-tenant incident management system, wherein the active incident management tenant is associated with an active user profile; identify a candidate set of messaging system tenants of the multi-tenant messaging system, wherein the candidate set of messaging system tenants are each respectively associated with the active user profile; generate an authenticated association between the active incident management tenant and a selected messaging system tenant of the candidate set of messaging system tenants, wherein the selected messaging system tenant defines at least one established authenticated association with another incident management tenant of the multi-tenant management system; generate an incident messaging data object based on an incident event data managed by the active incident management tenant; and output the incident messaging data object to the selected messaging system tenant of the multi-tenant messaging system, wherein the incident messaging data object is configured to cause rendering of an incident event interface component to a messaging interface of the selected messaging system tenant of the multi-tenant messaging system.

The computer program product further includes computer-readable program code portions configured to: receive, from the selected messaging system tenant of the multi-tenant messaging system, incident event data comprising an indication of an incident messaging action; determine a correct incident management tenant of the multi-tenant incident management system for transmission of the incident event data; output the incident event data to the correct incident management tenant of the multi-tenant incident management system; receive, from the correct incident management tenant, updated incident event data comprising an indication of an incident update based on the incident messaging action; generate an updated incident messaging data object based on the updated incident event data managed by the correct incident management tenant; determine a correct selected messaging system tenant of the multi-tenant messaging system for transmission of the updated incident messaging data object; and output the updated incident messaging data object to the correct selected messaging system tenant of the multi-tenant messaging system, wherein the updated incident messaging data object is configured to cause rendering of an incident event interface component to a messaging interface of the correct selected messaging system tenant of the multi-tenant messaging system.

The computer program product further includes where the active incident management tenant has an authenticated association with a plurality of selected messaging system tenants.

The computer program product further includes where the selected messaging system tenant has an authenticated association with a plurality of incident management tenants.

The computer program product further includes computer-readable program code portions configured to: request, prior to generation of the authenticated association between an active incident management tenant and a selected messaging system tenant, permission to access the selected messaging system tenant.

The computer program product further includes computer-readable program code portions configured to: determine, when a plurality of selected messaging system tenants have an authenticated association with the active incident management tenant, a correct selected messaging system tenant for transmission of the incident messaging data object.

The computer program product further includes computer-readable program code portions configured to: receive, from an incoming event queue, event data; cause, based at least in part on the event data, generation of an incident; and generate an authenticated association between the incident and an incident management tenant.

In one aspect, a computer-implemented method includes accessing an active incident management tenant of the multi-tenant incident management system, wherein the active incident management tenant is associated with an active user profile; identifying a candidate set of messaging system tenants of the multi-tenant messaging system, wherein the candidate set of messaging system tenants are each respectively associated with the active user profile; generating an authenticated association between the active incident management tenant and a selected messaging system tenant of the candidate set of messaging system tenants, wherein the selected messaging system tenant defines at least one established authenticated association with another incident management tenant of the multi-tenant management system; generating an incident messaging data object based on an incident event data managed by the active incident management tenant; and outputting the incident messaging data object to the selected messaging system tenant of the multi-tenant messaging system, wherein the incident messaging data object is configured to cause rendering of an incident event interface component to a messaging interface of the selected messaging system tenant of the multi-tenant messaging system.

The computer-implemented method further includes receiving, from the selected messaging system tenant of the multi-tenant messaging system, incident event data comprising an indication of an incident messaging action; determining a correct incident management tenant of the multi-tenant incident management system for transmission of the incident event data; outputting the incident event data to the correct incident management tenant of the multi-tenant incident management system; receiving, from the correct incident management tenant, updated incident event data comprising an indication of an incident update based on the incident messaging action; generating an updated incident messaging data object based on the updated incident event data managed by the correct incident management tenant; determining a correct selected messaging system tenant of the multi-tenant messaging system for transmission of the updated incident messaging data object; and outputting the updated incident messaging data object to the correct selected messaging system tenant of the multi-tenant messaging system, wherein the updated incident messaging data object is configured to cause rendering of an incident event interface component to a messaging interface of the correct selected messaging system tenant of the multi-tenant messaging system.

The computer-implemented method further includes where the active incident management tenant has an authenticated association with a plurality of selected messaging system tenants.

The computer-implemented method further includes where the selected messaging system tenant has an authenticated association with a plurality of incident management tenants.

The computer-implemented method further includes requesting, prior to generation of the authenticated association between an active incident management tenant and a selected messaging system tenant, permission to access the selected messaging system tenant.

The computer-implemented method further includes determining, when a plurality of selected messaging system tenants have an authenticated association with the active incident management tenant, a correct selected messaging system tenant for transmission of the incident messaging data object.

The computer-implemented method further includes receiving, from an incoming event queue, event data; causing, based at least in part on the event data, generation of an incident; and generating an authenticated association between the incident and an incident management tenant.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF SUMMARY OF THE DRAWINGS

Having thus described certain example embodiments of the present disclosure in general terms, reference will now be made to the accompanying drawings, which are not necessarily drawn to scale, and wherein:

FIG. 1 illustrates a block diagram of an example system within which one or more embodiments of the present disclosure may operate;

FIG. 2 illustrates a schematic diagram of an example tenant mapping and provisioning apparatus configured in accordance with one or more embodiments of the present disclosure;

FIG. 3 illustrates an example data flow for a tenant mapping and provisioning system that is configured in accordance with one or more embodiments of the present disclosure;

FIG. 4 illustrates example relationships of authenticated associations between incident management tenants and selected messaging system tenants in accordance with one or more embodiments of the present disclosure;

FIG. 5 illustrates an example incident management tenant configuration interface that is configured for enabling mapping one or more incident management tenants to one or more selected messaging system tenants in accordance with one or more embodiments of the present disclosure;

FIG. 6 illustrates an example multi-tenant messaging system permissions interface that is configured for authenticating associations between one or more incident management tenants and one or more selected messaging system tenants in accordance with one or more embodiments of the present disclosure;

FIG. 7 illustrates an example messaging system tenant selection interface for enabling mapping one or more incident management tenants to one or more channels of a selected messaging system tenant in accordance with one or more embodiments of the present disclosure;

FIG. 8 illustrates an example incident event interface component that is configured for rendering an incident messaging data object in accordance with one or more embodiments of the present disclosure;

FIG. 9 illustrates an example incident messaging action interface that is configured for performing incident messaging actions via a selected messaging system tenant in accordance with one or more embodiments of the present disclosure;

FIG. 10 illustrates an example incident event interface component resulting from performing incident messaging actions via a selected messaging system tenant in accordance with one or more embodiments of the present disclosure; and

FIG. 11 illustrates a flowchart diagram of an example process for mapping one or more incident management tenants to one or more selected messaging system tenants and provisioning incident messaging data objects for outputting to the one or more selected messaging system tenants in accordance with one or more embodiments of the present disclosure.

### DETAILED DESCRIPTION

### Overview

Modern software platforms have grown increasingly complex, often comprising hundreds or even thousands of services and microservices. This complexity has given rise to significant challenges in efficiently managing and triaging alerts and incidents that inevitably occur within these intricate systems. To address these challenges, enterprises have turned to multi-tenant incident management systems (e.g., Opsgenie or Jira Service Management (JSM) by Atlassian) and multi-tenant messaging systems (e.g., Slack by Slack Technologies or Microsoft Teams by Microsoft). However, the use of these multi-tenant systems introduces its own set of technical problems that must be overcome to ensure effective incident response and communication.

One of the primary technical challenges lies in the efficient integration and precise mapping between the multiple tenants of incident management systems and messaging systems. Each tenant within these systems may represent different teams, departments, or even separate organizations within a larger enterprise structure. The complexity arises from the need to ensure that alerts and incidents are routed to the appropriate tenants in both systems, while maintaining proper authentication and access controls.

Another significant technical problem is the authentication and authorization of users across multiple tenants in both the incident management and messaging systems. As users may have different roles and permissions within various tenants, ensuring secure and appropriate access to incident information and communication channels becomes a critical concern. This challenge is further compounded by the need to maintain data isolation between tenants while still allowing for necessary collaboration during incident resolution.

The present invention addresses these technical problems by providing a sophisticated tenant mapping and provisioning apparatus. This system is specifically designed to operate between a multi-tenant incident management system and a multi-tenant messaging system, effectively bridging the gap between these two critical components of modern IT operations.

The invention solves the complex problem of tenant mapping by implementing an intelligent mechanism to identify and associate the appropriate incident management tenant with the correct messaging system tenant. This mapping is not a simple one-to-one relationship but can handle scenarios where a single incident management tenant may need to interact with multiple messaging system tenants, or vice versa. This flexibility is crucial in accommodating the diverse organizational structures and operational workflows found in modern enterprises.

Furthermore, the invention addresses the authentication challenge by generating authenticated associations between tenants. This ensures that only authorized users can access and interact with incident information across different systems, maintaining the security and integrity of sensitive operational data. The system is designed to handle the complexities of multi-tenant environments, where a single user may have different levels of access across various tenants in both the incident management and messaging systems.

The invention also tackles the problem of efficient incident triage in complex software platforms. By generating incident messaging data objects based on incident event data and outputting these objects to the appropriate messaging system tenant, the invention ensures that critical information reaches the right teams quickly and in a format that is easily actionable within their preferred communication channels.

Moreover, the system's ability to render incident event interface components within the messaging interface of the selected messaging system tenant streamlines the incident response process. This integration allows responders to view and interact with incident information directly within their familiar messaging environment, reducing context switching and improving response times.

The invention's sophisticated approach to handling multi-tenant environments extends to its ability to determine the correct messaging system tenant for transmission of incident event data when multiple authenticated associations exist. This feature is particularly valuable in large, complex organizations where incidents may need to be communicated across various teams or departments, each potentially using different tenants within the messaging system.

By providing a comprehensive solution to these technical challenges, the invention enables organizations to leverage the power of multi-tenant incident management and messaging systems without being hindered by the complexities of tenant mapping, authentication, and efficient information routing. This results in improved incident response times, better collaboration across teams, and ultimately, more robust and reliable operation of complex software platforms.

### Definitions

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

The term “tenant mapping and provisioning system” refers to a system configured to efficiently integrate and precisely map between the multiple tenants of incident management systems and messaging systems. This system addresses the technical challenges that arise from the complexity of modern software platforms, which often comprise hundreds or even thousands of services and microservices.

The tenant mapping and provisioning system utilizes sophisticated algorithms and data structures to manage the relationships between tenants across different systems. It maintains a database of tenant information, which may be implemented as a relational database or a graph database, depending on the specific requirements of the system. This database stores critical metadata about each tenant, including authentication credentials, access permissions, and associated user profiles.

The tenant mapping and provisioning system is used to facilitate seamless communication and collaboration between teams using different tenants in incident management and messaging systems. It enables the efficient routing of alerts and incidents to the appropriate teams and channels, ensuring that critical information reaches the right people quickly. The system also manages the authentication and authorization processes, ensuring that users have the correct access rights across multiple tenants while maintaining data isolation and security.

The functionality of the tenant mapping and provisioning system extends beyond simple mapping. It also handles the provisioning of new tenants, automating the process of setting up and configuring new instances of incident management or messaging systems as organizations grow or restructure. This includes creating the necessary data structures, establishing initial access controls, and integrating the new tenant with existing systems.

The term “multi-tenant incident management system” refers to tools such as Opsgenie or Jira Service Management (JSM) by Atlassian that are configured to manage and triage alerts and incidents that occur in software platforms comprised of hundreds or even thousands of services or microservices. These systems are designed to handle the complexity of modern IT infrastructures while providing efficient incident response capabilities.

The architecture of a multi-tenant incident management system typically includes a centralized database that stores incident event data, alert configurations, and user information. This database may be implemented as a distributed system to ensure high availability and scalability, potentially using technologies like Apache Cassandra or Amazon DynamoDB. The system also incorporates a robust API layer that allows integration with various monitoring tools, communication platforms, and other IT management systems.

Multi-tenant incident management systems employ sophisticated event processing engines that can handle large volumes of incoming alerts from multiple sources. These engines use complex algorithms to correlate and deduplicate alerts, reducing noise and helping to identify the root cause of incidents more quickly. Machine learning models may be integrated into these systems to improve alert classification and prioritization over time, based on historical incident event data and resolution patterns.

These systems are used by IT operations teams, DevOps engineers, and site reliability engineers to monitor the health of their software platforms and respond quickly to any issues that arise. They provide features such as automated alert routing, escalation policies, on-call scheduling, and incident tracking. The multi-tenant nature of these systems allows organizations to manage incidents across different teams, projects, or even separate business units within a single platform while maintaining appropriate access controls and data isolation.

The functionality of multi-tenant incident management systems includes real-time alerting, incident lifecycle management, collaboration tools for incident response teams, and reporting and analytics capabilities. They often provide integrations with popular communication tools like Slack or Microsoft Teams, allowing responders to manage incidents directly from their preferred messaging interfaces.

Alternative uses or embodiments of multi-tenant incident management systems may include adaptation for non-IT domains, such as managing operational incidents in manufacturing environments or coordinating emergency response in public safety scenarios. The multi-tenant architecture could also be leveraged to create managed service provider (MSP) offerings, where a single instance of the system could be used to manage incidents for multiple client organizations.

The term “multi-tenant messaging system” refers to tools such as Slack by Slack Technologies or Microsoft Teams by Microsoft that are configured to support collaborative communication between enterprise teams and enterprise users. These systems provide a centralized platform for real-time messaging, file sharing, and integration with various business applications.

The architecture of a multi-tenant messaging system typically consists of a distributed backend infrastructure that can handle millions of concurrent connections and messages. This may include a combination of real-time messaging servers, database clusters for storing message history and user data, and content delivery networks (CDNs) for efficient file sharing. The system often employs WebSocket technology or similar protocols to enable instant message delivery and updates across devices.

Multi-tenant messaging systems implement sophisticated access control mechanisms to ensure data isolation between tenants while allowing for cross-tenant collaboration when necessary. This is typically achieved through a combination of role-based access control (RBAC) and fine-grained permissions systems. The backend may use a hierarchical data model to represent organizations, teams, channels, and users, which could be implemented using a graph database for efficient traversal and querying of complex organizational structures.

These systems are used by organizations of all sizes to facilitate internal communication, project collaboration, and integration of various business processes. They serve as a central hub for team interactions, allowing users to create topic-based channels, engage in direct messaging, and share files and other resources. The multi-tenant nature of these platforms enables large enterprises to manage communication across different departments, geographical locations, or even separate legal entities within a single instance of the system.

The functionality of multi-tenant messaging systems extends beyond basic chat capabilities. They often include features such as threaded conversations, @mentions for user notifications, search functionality across messages and files, and extensive integration capabilities with other business tools. Many of these systems also offer APIs and bot frameworks that allow organizations to build custom applications and automate workflows within the messaging environment.

The term “tenant” refers to specific instances or configurations of a software platform such as an incident management system or a messaging system. Tenants may represent different teams, departments, or even separate organizations within a larger enterprise structure. In some contexts, tenants may be referred to as “workspaces”. Users require authentication and specific access credentials/permissions to access selected tenants, especially in the context of incident management.

In the context of multi-tenant software architectures, a tenant is typically implemented as a logical partition within a shared software instance. This partitioning is achieved through a combination of database schema design, application logic, and access control mechanisms. For example, in a multi-tenant database, each tenant's data may be stored in separate tables or schemas, or a shared table may use a tenant identifier column to distinguish between different tenants' data.

The technical implementation of tenants often involves the use of middleware that intercepts database queries and application requests, applying tenant-specific filters and access controls. This middleware may leverage techniques such as row-level security in databases or aspect-oriented programming in application code to enforce data isolation between tenants. Additionally, tenant-specific configurations and customizations are typically stored in separate configuration databases or files, allowing for flexible customization without affecting the core application code.

Tenants are used to provide isolated environments within a shared software platform, enabling organizations to leverage the economies of scale offered by cloud-based multi-tenant systems while maintaining data privacy and security. In the context of incident management systems, tenants allow different teams or departments to manage their incidents and alerts independently, with their own set of users, roles, and configurations. Similarly, in messaging systems, tenants enable separate communication spaces for different parts of an organization or even different client organizations using the same platform.

The functionality of tenants includes providing customized user experiences, enforcing access controls, and enabling tenant-specific configurations and integrations. For example, a tenant in an incident management system may have its own set of alert rules, escalation policies, and integrations with monitoring tools. In a messaging system, a tenant may have its own set of collaborative messaging channels, user groups, and third-party app integrations. Each collaborative messaging channel associated with a messaging system tenant may be accessible by one or more users, groups, or teams who possess proper access credentials or permissions. The tenant mapping and provisioning system may be configured to manage associative relationships between collaborative messaging channels and messaging system tenants. Metadata such as tenant identifiers, channel identifiers, user identifiers, team identifiers, and/or the like may be utilized and stored by the tenant mapping and provisioning system to manage associations between collaborative messaging channels and messaging system tenants. In some embodiments, a collaborative messaging channel may be associated with one or more messaging system tenants.

Alternative uses or embodiments of tenants may include implementing virtual private cloud-like isolation in public cloud environments, creating sandboxed environments for software testing and development, or facilitating multi-brand management in e-commerce platforms. The concept of tenants can also be extended to create hierarchical structures, where sub-tenants exist within larger tenant environments, allowing for more granular organization and access control in complex enterprise scenarios.

The term “user profile” refers to a system repository for storing user information including access credentials, permissions, and associated data and metadata that is required for use by the tenant mapping and provisioning system. This centralized storage of user-specific information plays a crucial role in managing user interactions across multiple tenants and systems.

The technical implementation of a user profile typically involves a structured data storage system, which may be a relational database for efficient querying of user attributes, or a NoSQL database for more flexible schema design and scalability. The database schema for user profiles often includes tables or documents for core user information, roles and permissions, tenant associations, and activity logs. To ensure data integrity and security, the system may employ encryption for sensitive data fields and implement access control lists (ACLs) to manage who can read or modify user profile information.

User profiles are used by the tenant mapping and provisioning system to authenticate users, determine their access rights across different tenants, and personalize their experience within each tenant. When a user attempts to access a particular tenant or perform an action, the system queries the user profile to verify credentials and check permissions. The user profile also serves as a central point for managing user preferences, notification settings, and other customizable aspects of the user's interaction with the system.

The functionality of user profiles extends beyond basic authentication and authorization. They can be used to track user activity across tenants, enabling features such as audit trails and usage analytics. User profiles can also facilitate single sign-on (SSO) capabilities, allowing users to access multiple tenants or integrated systems without repeatedly entering credentials. Additionally, user profiles can store information about user skills, roles, and responsibilities, which can be leveraged for intelligent routing of incidents or messages within the system.

Alternative uses or embodiments of user profiles may include implementing adaptive user interfaces that change based on the user's role or preferences stored in their profile. User profiles could also be extended to support federated identity management, allowing organizations to maintain user information in their own identity providers while still enabling seamless access to the multi-tenant systems. In more advanced implementations, machine learning algorithms could analyze user profile data and activity patterns to provide personalized recommendations or automate certain tasks based on the user's typical behavior and preferences.

The term “candidate set of messaging system tenants” refers to a preliminary set of messaging system tenants that are defined based on information stored to an active user profile. This set represents the potential messaging system tenants that a user might interact with, based on their roles, permissions, and associations within the organization.

The technical implementation of a candidate set of messaging system tenants typically involves a combination of database queries and in-memory data structures. When a user logs in or initiates an action that requires tenant selection, the system performs a query against the user profile database to retrieve the user's tenant authenticated associations. This query may involve joining multiple tables or traversing a graph structure, depending on how the relationships between users and tenants are modeled in the database.

The candidate set of messaging system tenants is used to provide context-aware options to users when they need to interact with or switch between different messaging system tenants. For example, when a user needs to share an incident from an incident management system to a messaging system, the candidate set determines which messaging system tenants are available for selection. This helps streamline the user experience by presenting only relevant options and reducing the cognitive load on the user.

The functionality of the candidate set includes filtering and sorting capabilities to help users quickly find the most appropriate tenant for their current task. It may also include metadata about each tenant, such as the user's role within that tenant or the last time they accessed it, to provide additional context. The system may employ caching mechanisms to store frequently accessed candidate sets, improving performance for subsequent tenant selection operations.

Alternative uses or embodiments of the candidate set concept could include applying it to other types of resources beyond messaging system tenants. For example, it could be used to manage a set of candidate incident management tenants, project spaces, or even specific channels or teams within a messaging system. The concept could also be extended to implement a recommendation system that suggests the most likely tenants based on the user's current context, recent activity, or collaboration patterns with other users.

The term “authenticated association” refers to an integrated or mapped association between an active incident management tenant and a selected messaging system tenant that allows efficient transmission of incident event data from the active incident management tenant and the selected messaging system tenant without the need for persistent or renewed re-authentication. This concept is important for maintaining secure and seamless communication between different systems in a multi-tenant environment.

The technical implementation of an authenticated association typically involves the use of secure token-based authentication systems, such as JSON Web Tokens (JWT) or OAuth 2.0. When an association is established, the system generates a long-lived token or refresh token that represents the authenticated link between the two tenants. This token is securely stored, often encrypted, in a database or a distributed cache system like Redis, associated with both the incident management tenant and the messaging system tenant.

The authentication process may leverage public key infrastructure (PKI) for secure key exchange and digital signatures to ensure the integrity and authenticity of the association. The system might implement a token rotation mechanism to periodically refresh the authentication credentials without requiring user intervention, enhancing security while maintaining seamless operation.

Authenticated associations are used to facilitate rapid and secure communication between incident management and messaging systems. When data needs to be transmitted between associated tenants, the system can quickly validate the association using the stored token, without requiring the user to re-authenticate or manually authorize the data transfer each time. This significantly reduces latency in critical incident communication and improves the overall user experience.

The functionality of authenticated associations includes managing the lifecycle of these associations, including creation, validation, renewal, and revocation. The system may implement monitoring and logging mechanisms to track the usage of these associations, detecting and alerting on any suspicious activities. It may also include features for administrators to audit and manage these associations across their organization's tenants.

The term “incident event data” refers to data, metadata, or other information generated by an active incident management tenant to represent alerts, incidents, or the like. This data forms the core of incident management processes, capturing critical information about issues occurring within an organization's IT infrastructure or services.

The technical implementation of incident event data typically involves a structured data model that can represent various attributes of an incident. This may be implemented using a relational database schema with multiple tables to represent different aspects of an incident, or a NoSQL document store for more flexible schema evolution. The data model often includes fields for incident ID, severity, status, affected services, timestamp information, and associated alerts.

To handle high volumes of incident event data, the system may employ time-series databases optimized for storing and querying time-stamped data. For real-time processing of incident events, stream processing technologies like Apache Kafka or Apache Flink might be used to ingest, process, and distribute incident event data across the system.

Incident event data is used throughout the incident management lifecycle. It serves as the primary source of information for incident responders, providing them with the details needed to understand, triage, and resolve issues. The incident event data is also used to generate notifications, trigger automated responses, and populate dashboards and reports.

The functionality of incident event data extends to supporting various incident management processes. It enables features such as incident correlation, where related events are grouped to provide a holistic view of an ongoing issue. The incident event data can be analyzed to identify patterns and trends, supporting proactive incident prevention efforts. It also forms the basis for post-incident reviews and continuous improvement processes.

The term “incident messaging data object” refers to data, metadata, or other information representing incident event data but configured based on a format, template, or schema that is usable by the selected messaging system tenant to cause rendering of an incident event interface component to a messaging interface. This object serves as a bridge between the incident management system and the messaging system, translating raw incident event data into a format that can be effectively communicated and displayed within the messaging platform.

The system may employ template engines or code generation tools to dynamically create these data objects based on predefined schemas. These schemas would be designed to match the rendering capabilities and API requirements of the target messaging system. For complex transformations, the system might use data mapping libraries or custom transformation logic implemented in the application layer.

Incident messaging data objects are used to transmit incident information from the incident management system to the messaging system in a way that ensures proper rendering and interaction within the messaging interface. When an incident occurs or is updated, the system generates or updates the corresponding incident messaging data object and sends it to the appropriate messaging system tenant.

The functionality of incident messaging data objects includes supporting rich, interactive displays of incident information within messaging interfaces. This may include formatted text, status indicators, action buttons, and even interactive elements that allow users to respond to or update the incident directly from the messaging interface. The objects may also include metadata that enables features like message threading or notification controls within the messaging system.

Alternative uses or embodiments of incident messaging data objects could extend to supporting different types of messaging or collaboration platforms beyond traditional chat systems. For example, they could be adapted to generate email-friendly formats for incident notifications, or to create data structures suitable for voice-based incident reporting in virtual assistant systems. The concept could also be applied to other domains, such as creating standardized data objects for sharing project updates or customer support tickets across different communication platforms.

The term “incident event interface component” refers to a graphical user interface graphic, item, or portion that is configured to convey information associated with the incident event data to a user of the selected messaging system tenant. This component serves as the visual representation of an incident within the messaging system, providing users with at-a-glance information and interactive elements for managing the incident.

The technical implementation of an incident event interface component typically involves front-end web technologies such as HTML, CSS, and JavaScript. These components are often built using modern web frameworks like React, Vue.js, or Angular, which allow for the creation of reusable, interactive UI elements. The components may be implemented as custom extensions or plugins for the specific messaging platform being used.

Incident event interface components are used to present critical incident information within the familiar context of a user's messaging interface. They allow incident responders and stakeholders to view incident details, status updates, and relevant metrics without having to switch to a separate incident management tool. These components often include interactive elements that enable users to take actions directly from the messaging interface, such as acknowledging an incident, updating its status, or assigning it to a team member.

The functionality of incident event interface components includes providing a clear, concise summary of incident information, often using color coding or icons to indicate severity and status. They may include expandable sections for additional details, buttons for common actions, and links to more comprehensive views in the incident management system. Some implementations might include real-time updates, showing changes to the incident as they occur.

The term “messaging interface” refers to a graphical user interface of the selected messaging system tenant that is rendered to a display of a client device. This interface serves as the primary point of interaction for users engaging with the messaging system, providing access to conversations, channels, and integrated features like incident management components.

The technical implementation of a messaging interface typically involves a combination of front-end web technologies for browser-based access and native mobile application development for smartphone and tablet access. Web-based interfaces often use modern JavaScript frameworks like React or Vue.js, combined with CSS for styling and layout. Native mobile apps may be developed using platforms like React Native or Flutter for cross-platform compatibility or using native SDKs for iOS and Android for platform-specific optimizations.

To handle real-time updates and notifications, messaging interfaces often implement WebSocket connections or other real-time communication protocols. For efficient data management and smooth user experience, these interfaces may employ client-side caching mechanisms and virtual scrolling techniques to handle large volumes of messages and channels.

Messaging interfaces are used as the central hub for team communication and collaboration within an organization. They provide access to various communication channels, direct messaging capabilities, file sharing, and integrations with other business tools. In the context of incident management, the messaging interface serves as a platform for displaying incident event interface components, allowing users to stay informed about and interact with ongoing incidents without leaving their primary communication tool.

The functionality of messaging interfaces includes features such as message composition and sending, channel and conversation management, search capabilities, and user presence indicators. They often support rich media content, including images, videos, and file attachments. Advanced messaging interfaces may include features like message threading, reactions, and integrations with other productivity tools.

The term “monitored enterprise system” is used to refer to an enterprise software system that is monitored by a multi-tenant incident management system. The monitored enterprise software system may be configured to host or manage an enterprise credential management service among hundreds or thousands of other services or microservices.

The term “enterprise credential management service” is used to refer to a component or sub-system of a tenant mapping and provisioning system configured to manage user credentials, permissions, user profiles, etc., that are associated with the monitored enterprise system, one or more incident management tenants, and one or more selected messaging system tenants. In some embodiments, an enterprise credential management service is configured to communicate with a tenant mapping and provisioning system to provide user profile data including, without limitation, incident management tenant credentials and selected messaging system tenant credentials.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

The terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer may read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

The terms “client device,” “computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a component made available by a server. The server is often, but not always, on another computer system, in which case the client accesses the component by way of a network. Embodiments of client devices may include, without limitation, smartphones, tablet computers, laptop computers, personal computers, desktop computers, enterprise computers, and/or the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “repository” refers to a database, a datastore, and/or a memory device which is accessible by one or more computing devices for retrieval and storage of one or more data components, the like, or combinations thereof. The repository may be configured to organize data components stored therein in accordance with one or more particular data classification labels or other attributes attributed to the data component (e.g., a scoring metric, file size, file type, etc.). For example, a repository may be structured in accordance with one or more data components associated with one or more services, applications, data classification labels, internal resources, external resources, network functions, APIs, the like, or combinations thereof. In some embodiments, a repository may be at least partially stored on one or more of a server, remotely accessible by a computing device, or on a memory device on-board the computing device.

### Exemplary System Architectures, Methods, and Apparatuses

Methods, apparatuses, and computer program products of the present disclosure may be embodied by any of a variety of devices. For example, the method, apparatus, and computer program product of an example embodiment may be embodied by a networked device (e.g., an enterprise platform, etc.), such as a server, cloud platform, or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a PDA, mobile telephone, smartphone, laptop computer, tablet computer, wearable, the like or any combination of the aforementioned devices.

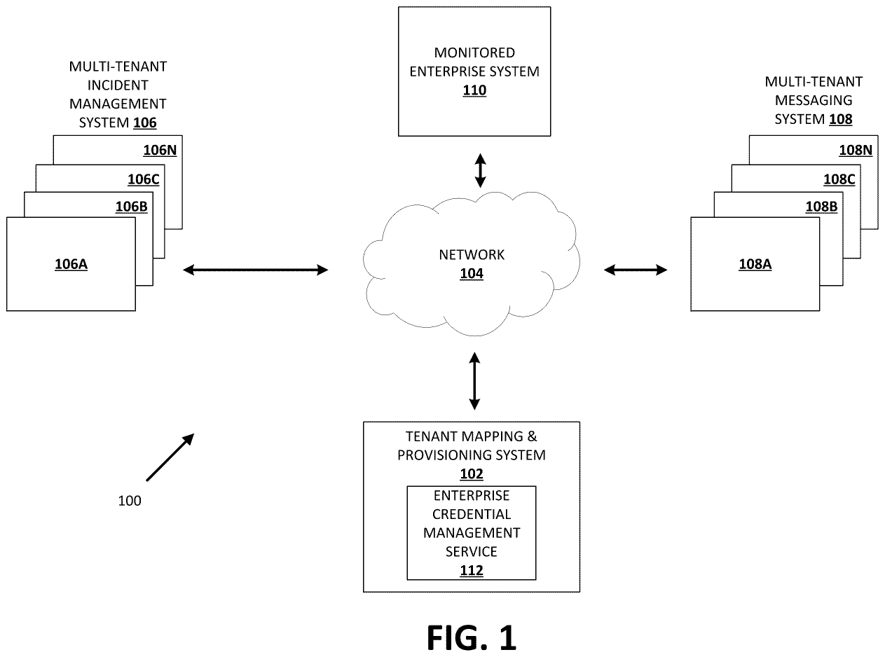

FIG. 1 illustrates an example system architecture 100 within which embodiments of the present disclosure operates. The system architecture 100 includes a tenant mapping and provisioning system 102 configured to interact with a multi-tenant incident management system 106 and a multi-tenant messaging system 108. The depicted multi-tenant incident management system comprises multiple incident management system tenants 106A-106N as shown. The depicted multi-tenant messaging system 108 includes multiple messaging system tenants 108A-108 N as shown.

The depicted tenant mapping and provisioning system 102 is further configured to interact with a monitored enterprise system 110. The depicted multi-tenant incident management system 106 is configured to monitor the monitored enterprise system 110. In various embodiments, the incident management system tenants 106A-106N of the multi-tenant incident management system 106 that are available to a particular user are defined by the tenant mapping and provisioning system 102 and, more particularly, are defined by the enterprise credential management service 112. In various embodiments, the messaging system tenants 108A-108N of the multi-tenant messaging system 108 that are available to a particular user are defined by the tenant mapping and provisioning system 102 and, more particularly, are defined by the enterprise credential management service 112.

In some embodiments, the functions and responsibilities of multi-tenant incident management system 106 and incident management tenants 106A-106N operate as dedicated services or operations deployed by a multi-tenant enterprise system and enterprise system tenants, respectively, which are configured with broader functionality. For example, in some embodiments, the multi-tenant enterprise system may be configured to manage enterprise workflows for a plurality of users across a plurality of enterprise system tenants.

The architecture of such example multi-tenant enterprise systems includes a centralized database that stores enterprise workflow data and user information. This database may be implemented as a distributed system to ensure high availability and scalability, potentially using technologies like Apache Cassandra or Amazon DynamoDB. The system also incorporates a robust API layer that allows integration with various enterprise workflow tools, communication platforms, and other software platforms.

The functionality of such example multi-tenant enterprise systems include workflow management, task scheduling and optimization, personnel management, collaboration tools, and workflow reporting and analytics. They are configured to provide integrations with popular communication tools like Slack or Microsoft Teams (e.g., multi-tenant messaging systems), allowing users to manage enterprise workflow operations directly from their preferred messaging interfaces.

Returning to FIG. 1, components of the depicted system architecture 100 utilizes a data repository (not shown) configured to store one or more data objects and/or data for one or more component objects associated therewith. In some embodiments, the one or more data objects stored in the data repository may include and/or may be stored with data sent to and/or received from the one or more components of system architecture 100. The data repository includes one or more storage units, such as multiple distributed storage units that are connected through a computer network. Each storage unit in the data repository stores one or more data objects. Moreover, each storage unit in the data repository includes one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

Components of system architecture 100 are each associated with computing devices configured to send and/or receive data directly or via a computer network, such as network 104. The tenant mapping and provisioning system 102, the multi-tenant incident management system 106, the multi-tenant messaging system 108, the monitored enterprise system 110, and/or the one or more devices associated therewith are in communication using a network 104. The network 104 includes any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 104 (e.g., network routers, etc.). For example, the network 104 may include a cellular telephone, an 802.11, 802.16, 802.20, and/or WiMAX network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JSON objects sent via a WebSocket channel. In some embodiments, the protocol is JSON over RPC, JSON over REST/HTTP, the like, or combinations thereof.

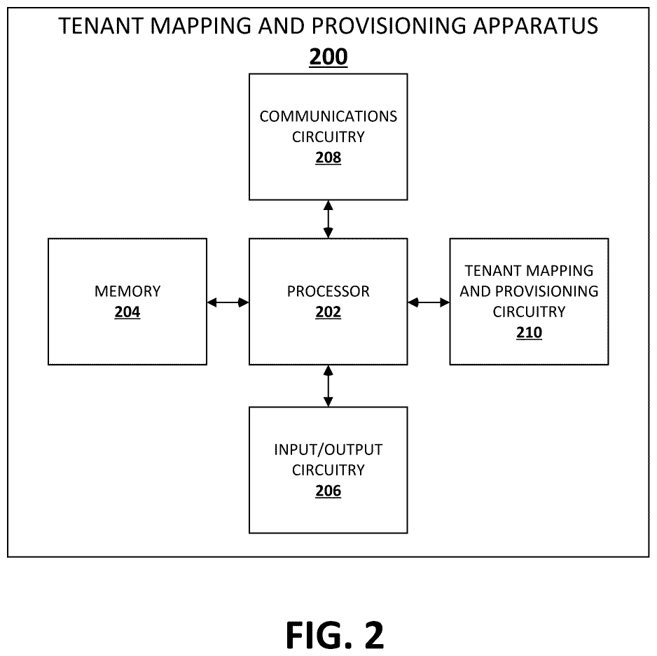

The invention disclosed herein may be embodied by one or more computing systems, such the tenant mapping and provisioning apparatus 200 illustrated in FIG. 2. In one or more embodiments, the tenant mapping and provisioning apparatus 200 includes processor 202, memory 204, input/output circuitry 206, communications circuitry 208, and/or tenant mapping and provisioning circuitry 210. The tenant mapping and provisioning apparatus 200 is configured to execute the operations described herein. Although these components 202-210 are described with respect to functional limitations, it should be understood that the particular implementations necessarily include the use of particular hardware. It should also be understood that certain of these components 202-210 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the techniques and/or operations described herein when the instructions are executed.

In some embodiments, the tenant mapping and provisioning apparatus 200 may include input/output circuitry 206 that may, in turn, be in communication with processor 202 to provide output to the user and, in some embodiments, to receive an indication of a user input. In some embodiments, the input/output circuitry 206 may be configured to render a user interface. Additionally or alternatively, the input/output circuitry 206 may be configured to render and/or control a display, and may comprise a web user interface, a mobile application, a query-initiating computing device, a kiosk, or the like. In some embodiments, the input/output circuitry 206 may be communicatively coupled to and/or include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the tenant mapping and provisioning system 102. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae.

In some embodiments, the communications circuitry 208 may act as an intermediary for one or more components of the system architecture 100. For example, the communications circuitry 208 may receive and process requests, call, messages, and/or the like for one or more components of the system architecture 100. In some embodiments, the communications circuitry 208 may additionally or alternatively support data routing, traffic control, security, decryption, encryption, optimization, and/or the like for data associated with one or more components of system architecture 100. For example, the communications circuitry 208 may receive a data object and perform one or more subsequent actions based on the data object. In some embodiments, the communications circuitry 208 may provide functionality of a service proxy for one or more components of the system architecture 100. In some embodiments, the communications circuitry 208 may also be configured to generate access logs and/or historical data including information associated with a particular computing device, component, component object, the like, or combinations thereof.

The tenant mapping and provisioning circuitry 210 may be any means such as a device or circuitry embodied in either hardware or a combination of hardware and software that is configured to interact with the system architecture 100 and/or the one or more components of the system architecture 100. For example, the tenant mapping and provisioning circuitry 210 may be any means such as a device or circuitry embodied in either hardware or a combination of hardware and software that is configured to interact with the tenant mapping and provisioning system 102, multi-tenant incident management system 106, multi-tenant messaging system 108, monitored enterprise system 110, and/or the enterprise credential management service 112.

In some embodiments, one or more external systems (such as a remote cloud computing and/or data storage system) may also be leveraged to provide at least some of the functionality discussed herein.

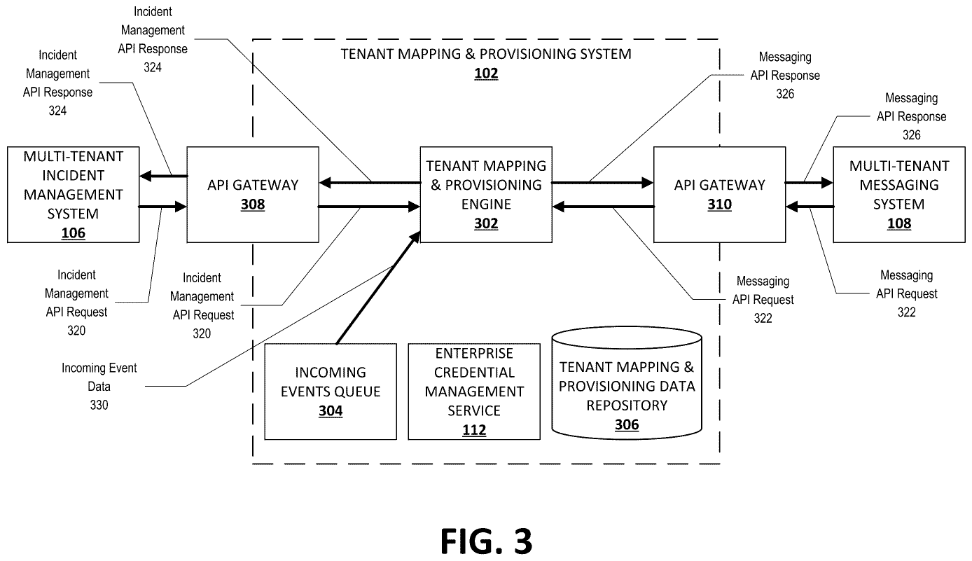

FIG. 3 illustrates an example data flow presented in accordance with one or more embodiments of the present disclosure. The data flow depicts functionality between various sub-systems of the present disclosure, including tenant mapping and provisioning system 102, multi-tenant incident management system 106, and multi-tenant messaging system 108. One or more portions of the data flow is executed and/or performed by tenant mapping and provisioning apparatus 200 of FIG. 2.

The depicted tenant mapping and provisioning system 102 utilizes tenant mapping and provisioning engine 302, incoming events queue 304, tenant mapping and provisioning data repository 306, enterprise credential management service 112, API gateway 308, and API gateway 310 to perform tenant mapping and provisioning functionality.

The depicted tenant mapping and provisioning engine 302 is embodied by tenant mapping and provisioning apparatus 200 and is configured to carry out the computational functionality of tenant mapping and provisioning system 102.

The depicted incoming events queue 304 is configured to receive and store incoming event data 330 from various alternative sources such as monitored enterprise system 110 or enterprise credential management service 112. In various embodiments, incident event data managed by monitored enterprise system 110 or credential data managed by enterprise credential management service 112 that is relevant to the function of tenant mapping and provisioning system 102 will be received and stored by incoming events queue 304.

The depicted tenant mapping and provisioning data repository 306 is configured to store any data relevant to the operation of tenant mapping and provisioning system 102. All data relating to tenant mapping and the generation and updating of incident messaging data objects are stored in tenant mapping and provisioning data repository 306.

The depicted API gateway 308 is configured to interface with multi-tenant incident management system 106 to enable communication between tenant mapping and provisioning system 102 and multi-tenant incident management system 106 and the incident management tenants contained therewith. The depicted API gateway 310 is configured to interface with multi-tenant messaging system 108 to enable communication between tenant mapping and provisioning system 102 and multi-tenant messaging system 108 and the messaging system tenants contained therewith.

The depicted tenant mapping and provisioning engine 302 is configured to create and maintain a tenant map of authenticated associations between incident management tenants and selected messaging system tenants. This tenant map is stored in tenant mapping and provisioning data repository 306. The tenant map is referenced by tenant mapping and provisioning engine 302 to ensure proper routing of incident event data, updated incident event data, and data associated with incident messaging actions, between incident management tenants and selected messaging system tenants.

The depicted tenant mapping and provisioning engine 302 receives an incident management API request 320 from an incident management tenant via multi-tenant incident management system 106 via API gateway 308. Incident management API request 320 contains data which, when processed by tenant mapping and provisioning engine 302, causes tenant mapping and provisioning engine 302 to perform actions including but not limited to creating an authenticated association between an incident management tenant and a selected messaging system tenant, removing an authenticated association between an incident management tenant and a selected messaging system tenant, authenticating an association between an incident management tenant and a selected messaging system tenant to define an authenticated association, generating one or more incident messaging data objects, updating one or more incident messaging data objects, or routing the one or more incident messaging data objects to the appropriate selected messaging system tenant.

In response to incident management API request 320, tenant mapping and provisioning engine 302 is configured to generate an incident management API response 324 for transmission to an incident management tenant via multi-tenant incident management system 106 via API gateway 308. Incident management API response 324 is configured to notify multi-tenant incident management system 106 of successful creation, removal, and/or authentication of an association between an incident management tenant and a selected messaging system tenant, successful generation of an incident messaging data object, or of any errors which occurred during attempted execution of any of the aforementioned actions. In various embodiments, incident management API response 324 may contain data indicative of an incident messaging action triggered by a selected messaging system tenant via an interface displaying an incident messaging data object.

In the depicted embodiment, tenant mapping and provisioning engine 302 receives a messaging API request 322 from a selected messaging system tenant via multi-tenant messaging system 108 via API gateway 310. Messaging API request 322 contains data which, when processed by tenant mapping and provisioning engine 302, cause tenant mapping and provisioning engine 302 to perform actions including but not limited to routing data indicative of an incident messaging action to an appropriate incident management tenant, creating an authenticated association between an incident management tenant and a selected messaging system tenant, removing an authenticated association between an incident management tenant and a selected messaging system tenant, or authenticating an association between an incident management tenant and a selected messaging system tenant.

In the depicted embodiment, in response to messaging API request 322, tenant mapping and provisioning engine 302 generates a messaging API response 326 for transmission to a selected messaging system tenant via multi-tenant messaging system 108 via API gateway 310. Messaging API response 326 is configured to notify multi-tenant messaging system 108 of successful creation, removal, and/or authentication of an association between an incident management tenant and a selected messaging system tenant, or of any errors which occurred during attempted execution of any of the aforementioned actions. In various embodiments, messaging API response 326 contains new or updated incident messaging data objects, as well as data indicating the appropriate selected messaging system tenant for receipt of the data.

In various embodiments, a selected messaging system tenant may have its own set of collaborative messaging channels. The tenant mapping and provisioning system 102 may be configured to route incident event data, incident messaging data objects, or messaging API response 326 to one or more collaborative messaging channels associated with the selected messaging system tenant. In various embodiments, data associating one or more collaborative messaging channels to the selected messaging system tenant may be stored in tenant mapping and provisioning data repository 306.

In the depicted embodiment, incoming events queue 304 is configured to receive and store incoming event data 330 from various alternative sources such as monitored enterprise system 110 or enterprise credential management service 112. Tenant mapping and provisioning system 102 queries enterprise credential management service 112 to facilitate authentication of associations between incident management tenants and selected messaging system tenants. Incoming event data 330 containing incident event data is configured to cause tenant mapping and provisioning engine 302 to retrieve an incident messaging data object from tenant mapping and provisioning data repository 306, update the incident messaging data object based on the incoming event data 330, and transmit the updated incident messaging data object to multi-tenant messaging system 108 via API gateway 310.

In various embodiments, incoming event data 330 may be received from multi-tenant incident management system 106 via API gateway 308.

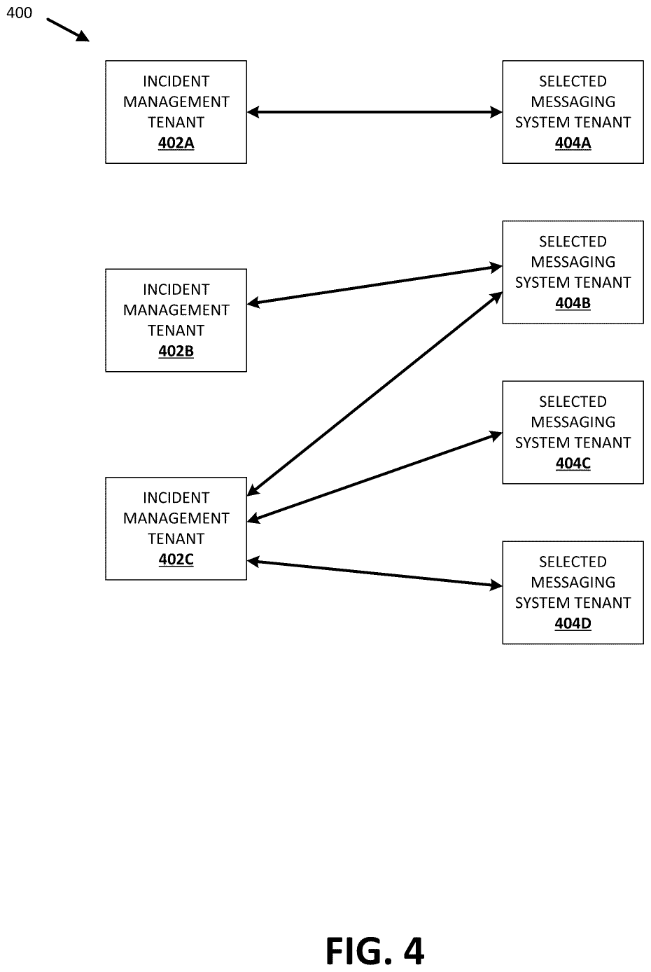

FIG. 4 illustrates an example tenant map 400 generated and maintained by tenant mapping and provisioning system 102 and stored in tenant mapping and provisioning data repository 306. To visualize the tenant map 400, double sided arrows have been drawn between a plurality of incident management tenants 402A-402C and a plurality of selected messaging system tenants 404A-404D. These arrows signify the establishment of an authenticated association between the tenants. In the tenant map 400, incident management tenant 402A has an authenticated association with selected messaging system tenant 404A, incident management tenant 402B has an authenticated association with selected messaging system tenant 404B, incident management tenant 402C has an authenticated association with selected messaging system tenant 404B, incident management tenant 402C has an authenticated association with selected messaging system tenant 404C, and incident management tenant 402C has an authenticated association with selected messaging system tenant 404D.

In various embodiments, a single incident management tenant may have an authenticated association with a single selected messaging system tenant, such as with incident management tenant 402A and selected messaging system tenant 404A. In various embodiments, a single incident management tenant may have an authenticated association with multiple selected messaging system tenants, such as with incident management tenant 402c and selected messaging system tenants 404B-404D. In various embodiments, a single selected messaging system tenant may have an authenticated association with multiple incident management tenants, such as with selected messaging system tenant 404B and incident management tenants 402B-402C.

In the depicted embodiment, tenant map 400 is continuously updated by tenant mapping and provisioning system 102 as tenant authenticated associations are created and removed. In various embodiments, tenant map 400 is referenced by tenant mapping and provisioning system 102 to ensure proper routing of data between authentically associated tenants. For example, when data associated with an incident messaging action generated in association with an incident messaging data object from selected messaging system tenant 404B needs to be routed to the correct incident management tenant due to the selected messaging system tenant's 404B authenticated association with multiple incident management tenants, tenant map 400 is referenced by tenant mapping and provisioning system 102 when making the routing decision.

In various embodiments, tenant map 400 may also be configured to manage associations between one or more selected messaging system tenants and one or more collaborative messaging channels.

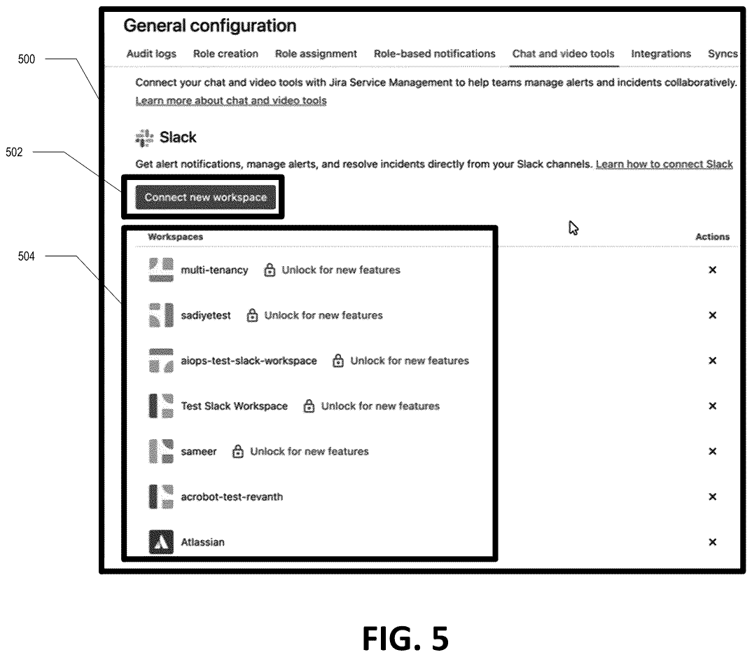

FIG. 5 illustrates an example incident management tenant configuration interface 500. In various embodiments, incident management tenant configuration interface 500 comprises a tenant association creation interface element 502 and a selected messaging system tenant associations interface element 504.

In the depicted embodiment, incident management tenant configuration interface 500 is configured to be rendered by a device associated with an active incident management tenant of a multi-tenant incident management system. Incident management tenant configuration interface 500 also enables a user to access an active incident management tenant of a multi-tenant incident management system, wherein the active incident management tenant is associated with an active user profile.

In the depicted embodiment, tenant association creation interface element 502 is configured to enable a user of an active incident management tenant to initiate a process configured to create an authenticated association between the active incident management tenant and one or more messaging system tenants of a candidate set of messaging system tenants of a multi-tenant messaging system.

In the depicted embodiment, selected messaging system tenant associations interface element 504 is configured to illustrate a list of selected messaging system tenants that have already defined and established an authenticated association with the active incident management tenant.

In the depicted embodiment, incident management tenant configuration interface 500 also enables a user of an active incident management tenant to remove an authenticated association from a selected messaging system tenant.

In the depicted embodiment, the active incident management tenant is configured to communicate and share incident event data with tenant mapping and provisioning system 102 via multi-tenant incident management system 106 in the form of incident management API request 320 and incident management API response 324 as described with reference to FIG. 3 above.

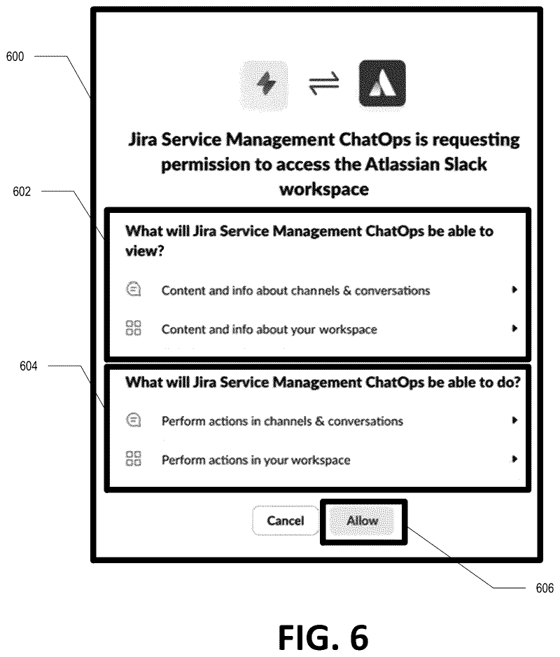

FIG. 6 illustrates an example multi-tenant messaging system permissions interface 600. Multi-tenant messaging system permissions interface 600 is configured to enable a user to enact data access control via interface element 602, data action control via interface element 604, and proceed with a messaging system tenant authenticated association process via interface element 606.

In the depicted embodiment, multi-tenant messaging system permissions interface 600 is configured to be rendered by a device associated with an active incident management tenant of a multi-tenant incident management system. Multi-tenant messaging system permissions interface 600 is also configured to be displayed upon user interaction with tenant association creation interface element 502.

In the depicted embodiment, user interaction with interface element 606 enables a multi-tenant incident management system to access and manipulate data within a multi-tenant messaging system. In various embodiments, user interaction with interface element 606 enables a tenant mapping and provisioning system 102 to retrieve and store multi-tenant messaging system credential data in enterprise credential management service 112. Multi-tenant messaging system credential data is utilized by tenant mapping and provisioning system 102 to validate and authenticate users of a messaging system tenant of a multi-tenant messaging system.

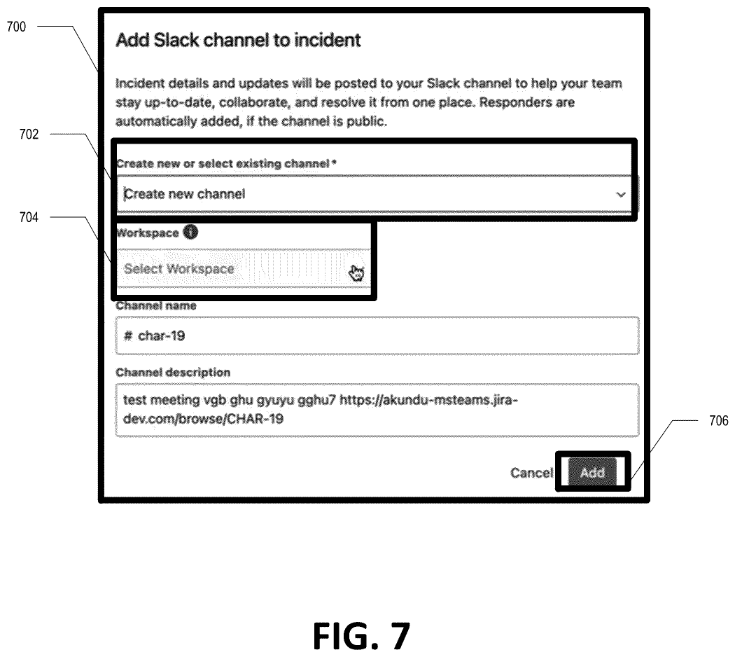

FIG. 7 illustrates an example messaging system tenant selection interface 700. Messaging system tenant selection interface 700 is configured to enable a user to authentically associate the active incident management tenant with a new or existing multi-tenant messaging system via interface element 702, select an eligible messaging system tenant of the chosen multi-tenant messaging system from a candidate set of messaging system tenants via interface element 704, and confirm the creation of an authenticated association between the active incident management tenant and the selected messaging system tenant via interface element 706.

In the depicted embodiment, messaging system tenant selection interface 700 is configured to be rendered by a device associated with an active incident management tenant of a multi-tenant incident management system. Messaging system tenant selection interface 700 is also configured to be displayed upon user interaction with interface element 606.

In the depicted embodiment, interface element 702 identifies a candidate set of collaborative messaging channels of a selected messaging system tenant of a multi-tenant messaging system, wherein the candidate set of messaging system tenants are each respectively associated with the active user profile. In some embodiments, interface element 702 may also be configured to enable a user to create a new collaborative messaging channel and associate the new collaborative messaging channel with the selected messaging system tenant.

In the depicted embodiment, interface element 704 identifies a candidate set of messaging system tenants of a multi-tenant messaging system, wherein the candidate set of messaging system tenants are each respectively associated with the active user profile.

In the depicted embodiment, tenant mapping and provisioning system 102 queries enterprise credential management service 112 when determining the candidate set of eligible messaging system tenants of the chosen multi-tenant messaging system. In various embodiments, the candidate set may not include eligible messaging system tenants that are determined to already define an established, authenticated association with the active incident management tenant in accordance with tenant map 400. In various embodiments, user interaction with interface element 704 to select a messaging system tenant from the candidate set designates the selected messaging system tenant as the selected messaging system tenant.

In the depicted embodiment, user interaction with interface element 706 triggers a process to authenticate and associate the active incident management tenant and the selected messaging system tenant. This process is performed by tenant mapping and provisioning system 102.

In various embodiments, user interaction with interface element 706 generates an authenticated association between an active incident management tenant and a selected messaging system tenant of the candidate set of messaging system tenants, wherein the selected messaging system tenant defines at least one established authenticated association with another incident management tenant of the multi-tenant management system.

In the depicted embodiment, data relating to a user's indication to create an authenticated association between the active incident management tenant and the selected messaging system tenant is encapsulated within an incident management API request 320 for transmission to the tenant mapping and provisioning system 102.

In the depicted embodiment, the active incident management tenant is configured to communicate and share incident event data with tenant mapping and provisioning system 102 via multi-tenant incident management system 106 in the form of incident management API request 320 and incident management API response 324 as described with reference to FIG. 3 above.

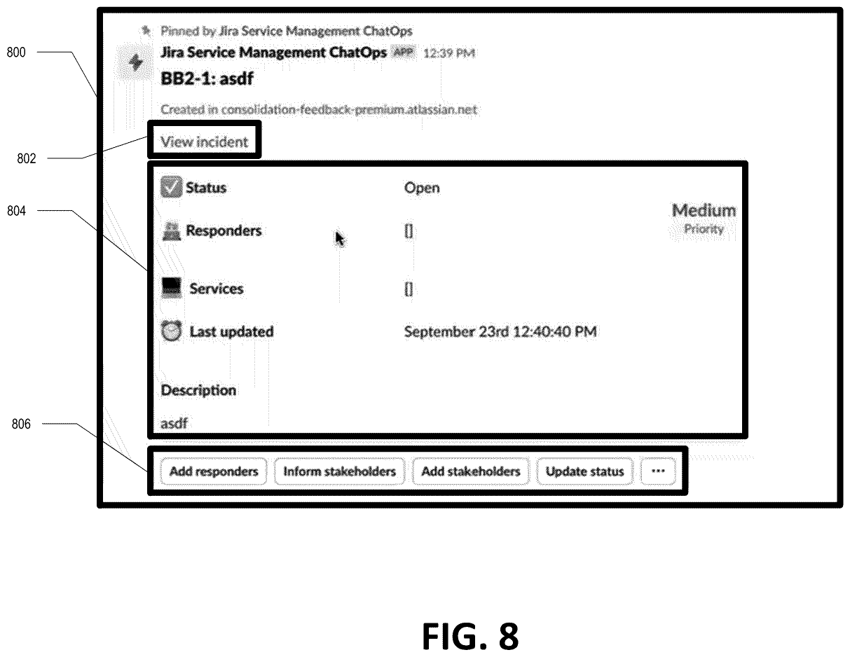

FIG. 8 illustrates an example incident event interface component 800. In various embodiments, incident event interface component 800 enables a user to view an incident and incident event data via interface element 802, view incident properties via interface element 804, and initiate incident messaging actions via incident messaging action interface elements 806.

In the depicted embodiment, incident event interface component 800 is configured to be rendered to a messaging interface of the selected messaging system tenant of the multi-tenant messaging system by a device associated with a selected messaging system tenant of a multi-tenant messaging system. In alternative embodiments, incident event interface component 800 may be configured to be rendered to a messaging interface of a selected collaborative messaging channel associated with the selected messaging system tenant by a device associated with a selected messaging system tenant of a multi-tenant messaging system. In various embodiments, incident event interface component 800 is configured to be rendered upon a selected messaging system tenant receiving an incident messaging data object generated by the tenant mapping and provisioning system 102. In various embodiments, an incident messaging data object may be encapsulated within a messaging API response 326 for transmission to a multi-tenant messaging system authentically associated with the selected messaging system tenant.

In various embodiments, the incident messaging data object generated by tenant mapping and provisioning system 102 is based on incident event data managed by the active incident management tenant.

In the depicted embodiment, the selected messaging system tenant is configured to communicate and share data with tenant mapping and provisioning system 102 via multi-tenant messaging system 108 in the form of messaging API request 322 and messaging API response 326 as described with reference to FIG. 3 above.

In the depicted embodiment, interface element 802 is configured to enable a user to an incident and incident event data. This incident event data is based at least in part on data contained within an incident messaging data object. Incidents and incident event data originating from and are managed by the incident management tenant authentically associated with the selected messaging system tenant. In the depicted embodiment, an incident messaging tenant notifies the tenant mapping and provisioning system 102 of changes to an incident and its associated incident event data. Upon receiving updated incident event data, the tenant mapping and provisioning system generates an updated incident messaging data object for proper routing and transmission to one or more selected messaging system tenants for rendering by incident event interface component 800.

In the depicted embodiment, interface element 804 enables users to view incident properties. Incident properties include, without limitation, incident status, incident type, user profiles associated with the incident, services associated with the incident, timestamps indicating when the incident event interface component 800 was last updated by tenant mapping and provisioning system 102, one or more incident descriptions, and one or more incident priority levels.

In the depicted embodiment, incident messaging action interface elements 806 enables users to quickly trigger incident messaging actions associated with an incident. Available incident messaging actions vary based on incident status, incident type, user permissions, and/or the like.

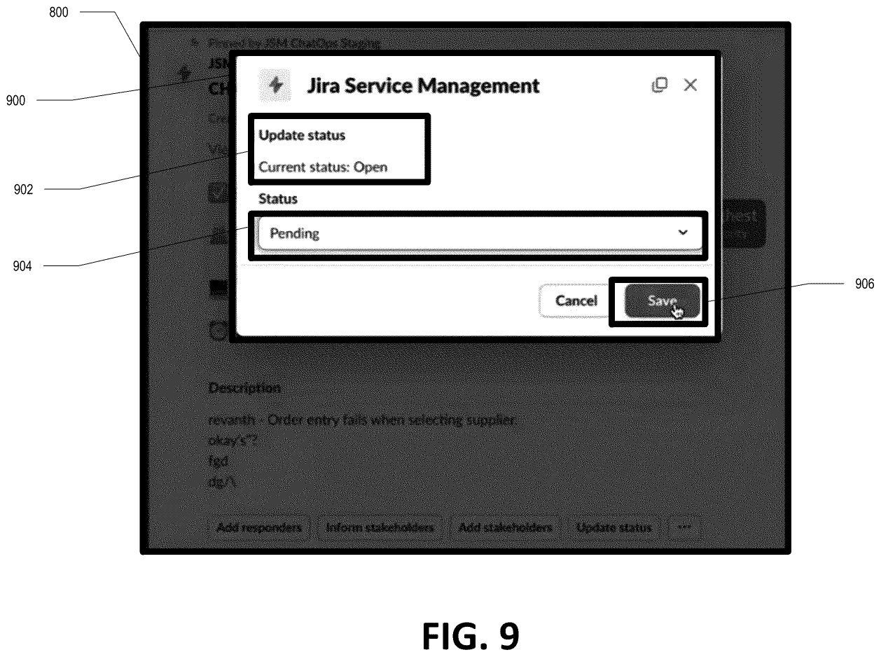

FIG. 9 illustrates an example incident messaging action interface 900. In various embodiments, incident messaging action interface 900 is configured to enable users to view incident event data relevant to the incident messaging action selected by the user via interface element 902, configure the incident messaging action based on a plurality of incident messaging action options displayed via interface element 904, and trigger transmission of data associated with the incident messaging action to tenant mapping and provisioning system 102 in the form of a messaging API request 322.

In the depicted embodiment, the tenant mapping and provisioning system 102 is configured to properly route and transmit the data associated with the incident messaging action to one or more incident management tenants in accordance with tenant map 400. In various embodiments, the incident management tenant which receives the data associated with the incident messaging action will perform and execute any functions necessary to carry out the incident messaging action.

In the depicted embodiment, the selected messaging system tenant is configured to communicate and share data with tenant mapping and provisioning system 102 via multi-tenant messaging system 108 in the form of messaging API requests 322 and messaging API response 326 as described with reference to FIG. 3 above.

In the depicted embodiment, the incident messaging action interface 900 is configured to be rendered by a device associated with a selected messaging system tenant of a multi-tenant messaging system. In alternative embodiments, incident messaging action interface 900 may be configured to by rendered to a messaging interface of a selected collaborative messaging channel associated with the selected messaging system tenant by a device associated with a selected messaging system tenant of a multi-tenant messaging system. Incident messaging action interface 900 is also configured to be displayed upon user interaction with incident messaging action interface elements 806.

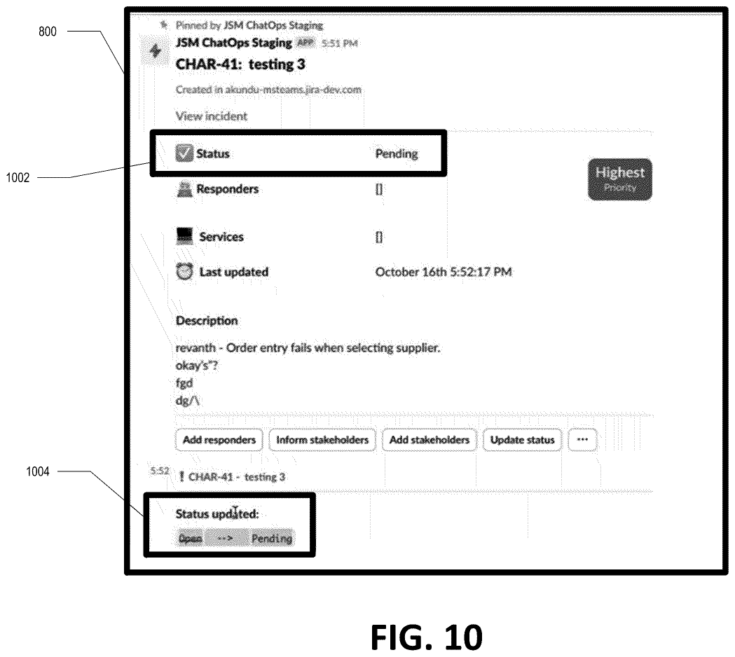

FIG. 10 illustrates an example incident event interface component 800 after it has been updated in accordance with the processes described with reference to FIGS. 3, 8, and 9 above. For example, as shown in FIG. 9, a user with permission to access the selected messaging system tenant has interacted with incident messaging action interface 900 to change the status of an incident from “open” to “pending”.

In the depicted embodiment, upon receiving an updated incident messaging data object from tenant mapping and provisioning system 102 in the form of a messaging API response 326, a device associated with the selected messaging system tenant renders the updated incident messaging data object as incident event interface component 800. In alternative embodiments, incident event interface component 800 may be configured to be rendered to a messaging interface of a selected collaborative messaging channel associated with the selected messaging system tenant. As noted by block 1002 for this example, the status of the incident is now displayed as “pending” and interface element 1004 indicates to a user that the status has successfully been updated from “open” to “pending”.

By way of an example, other aspects of incident event interface component 800 have been updated by other incident messaging actions. These updates include but are not limited to updating the priority level from “medium” to “highest”, updating the incident description, updating the incident title, and the like.

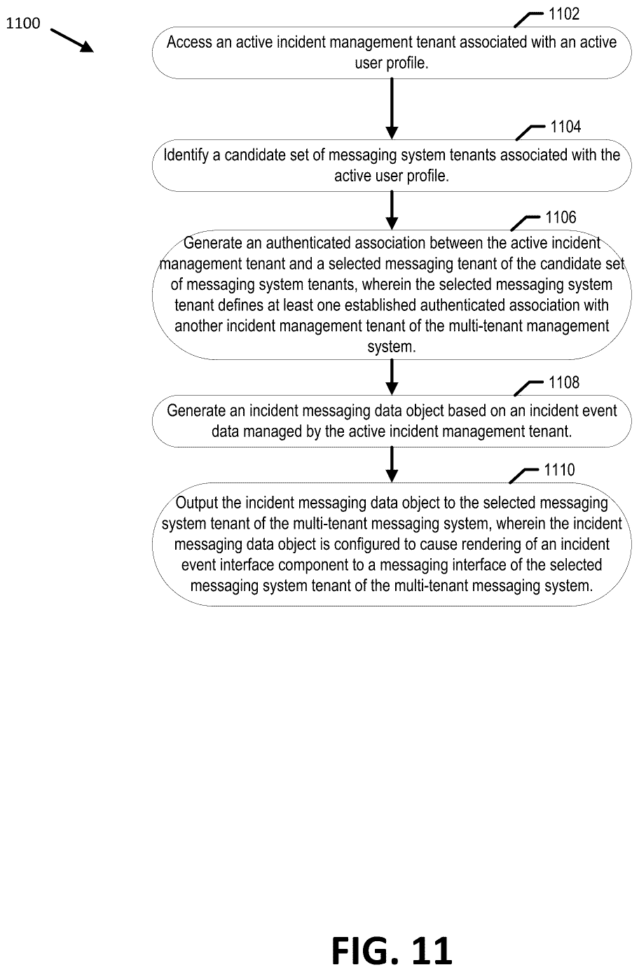

FIG. 11 is a flowchart diagram of an example process 1100 for facilitating multi-tenant enterprise messaging integrations via a tenant mapping and provisioning system 102.

At block 1102, a tenant mapping and provisioning system 102 accesses an active incident management tenant of the multi-tenant incident management system, wherein the active incident management tenant is authentically associated with an active user profile. In the depicted embodiment, an incident management tenant is considered “active” when a user profile associated with the incident management tenant is logged in to the multi-tenant incident management system and interacting with the incident management tenant.

At block 1104, a tenant mapping and provisioning system 102 identifies a candidate set of messaging system tenants of the multi-tenant messaging system, wherein the candidate set of messaging system tenants are each respectively associated with the active user profile. In various embodiments, the tenant mapping and provisioning system 102 queries the enterprise credential management service 112 and/or a tenant map 400 to determine the candidate set of messaging system tenants eligible to be authentically associated with the active incident management tenant. In various embodiments, a messaging system tenant may be excluded from the candidate set if the tenant mapping and provisioning system 102 determines that the active incident management tenant has already defined an established, authenticated association to that messaging system tenant in accordance with tenant map 400. In various embodiments, a messaging system tenant may be excluded from the candidate set if the tenant mapping and provisioning system 102 determines that the active user profile does not have permission to authentically associate the active incident management tenant with that messaging system tenant in accordance with enterprise credential management service 112.

At block 1106, the tenant mapping and provisioning system 102 generates an authenticated association between the active incident management tenant and a selected messaging system tenant of the candidate set of messaging system tenants, wherein the selected messaging system tenant defines at least one established authenticated association with another incident management tenant of the multi-tenant management system. In various embodiments, the authenticated association is authenticated in accordance with multi-tenant incident management credentials and multi-tenant messaging system credentials maintained by enterprise credential management service 112. In various embodiments, the authenticated association may be authenticated via user interaction with multi-tenant messaging system permissions interface 600.

In the depicted embodiment, the selected messaging system tenant of the candidate set of messaging system tenants is determined via user interaction with messaging system tenant selection interface 700.

In various embodiments, the authenticated association generated by tenant mapping and provisioning system 102 is maintained by tenant map 400 stored in tenant mapping and provisioning data repository 306.

At block 1108, the tenant mapping and provisioning system 102 generates an incident messaging data object based on an incident event data managed by the active incident management tenant. In various embodiments, incident event data is also managed by a monitored enterprise system 110 and therefore received by the tenant mapping and provisioning system 102 via incoming events queue 304.

In the depicted embodiment, the incident messaging data object is configured to provide enterprise messaging functionality to a selected messaging tenant of a multi-tenant messaging system.

At block 1110, the tenant mapping and provisioning system 102 is configured to output the incident messaging data object to the selected messaging system tenant of the multi-tenant messaging system, wherein the incident messaging data object is configured to cause rendering of an incident event interface component to a messaging interface of the selected messaging system tenant of the multi-tenant messaging system.

In the depicted embodiment, incident event interface component 800 is configured to render the incident messaging data object to a messaging interface of the selected messaging system tenant of the multi-tenant messaging system.

In various embodiments, the tenant mapping and provisioning system may configure the incident messaging data object for transmission to the multi-tenant messaging system in the form of a messaging API response 326.

It should be readily appreciated that the embodiments of the systems and apparatuses, described herein may be configured in various additional and alternative manners in addition to those expressly described herein.

### CONCLUSION

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this detailed description has set forth some embodiments of the present invention, the appended claims cover other embodiments of the present invention which differ from the described embodiments according to various modifications and improvements.

Within the appended claims, unless the specific term “means for” or “step for” is used within a given claim, it is not intended that the claim be interpreted under 35 U.S.C. § 112, paragraph 6.

1. A tenant mapping and provisioning apparatus that is configured for operation between a multi-tenant incident management system and a multi-tenant messaging system, wherein the tenant mapping and provisioning apparatus comprises one or more processors and one or more memories storing instructions that are operable, when executed by the one or more processors, to cause the tenant mapping and provisioning apparatus to:
access an active incident management tenant of the multi-tenant incident management system, wherein the active incident management tenant is associated with an active user profile;
identify a candidate set of messaging system tenants of the multi-tenant messaging system, wherein the candidate set of messaging system tenants are each respectively associated with the active user profile;
generate an authenticated association between the active incident management tenant and a selected messaging system tenant of the candidate set of messaging system tenants, wherein the selected messaging system tenant defines at least one established authenticated association with another incident management tenant of the multi-tenant incident management system;
generate an incident messaging data object based on incident event data managed by the active incident management tenant; and
output the incident messaging data object to the selected messaging system tenant of the multi-tenant messaging system, wherein the incident messaging data object is configured to cause rendering of an incident event interface component to a messaging interface of the selected messaging system tenant of the multi-tenant messaging system, and wherein the incident event interface component is configured to enable triggering of one or more incident messaging actions associated with the incident event data through the messaging interface.

2. The tenant mapping and provisioning apparatus of claim 1, wherein the one or more processors and one or more memories storing instructions are further operable, when executed by the one or more processors, to cause the tenant mapping and provisioning apparatus to:
receive, from the selected messaging system tenant of the multi-tenant messaging system, incident event data comprising an indication of an incident messaging action;
determine a correct incident management tenant of the multi-tenant incident management system for transmission of the incident event data;
output the incident event data to the correct incident management tenant of the multi-tenant incident management system;
receive, from the correct incident management tenant, updated incident event data comprising an indication of an incident update based on the incident messaging action;
generate an updated incident messaging data object based on the updated incident event data managed by the correct incident management tenant;
determine a correct selected messaging system tenant of the multi-tenant messaging system for transmission of the updated incident messaging data object; and
output the updated incident messaging data object to the correct selected messaging system tenant of the multi-tenant messaging system, wherein the updated incident messaging data object is configured to cause rendering of an incident event interface component to a messaging interface of the correct selected messaging system tenant of the multi-tenant messaging system.

3. The tenant mapping and provisioning apparatus of claim 1, wherein the active incident management tenant has an authenticated association with a plurality of selected messaging system tenants.

4. The tenant mapping and provisioning apparatus of claim 1, wherein the selected messaging system tenant has an authenticated association with a plurality of incident management tenants.

5. The tenant mapping and provisioning apparatus of claim 1, wherein the one or more processors and one or more memories storing instructions are further operable, when executed by the one or more processors, to cause the tenant mapping and provisioning apparatus to:
request, prior to generation of the authenticated association between an active incident management tenant and a selected messaging system tenant, permission to access the selected messaging system tenant.

6. The tenant mapping and provisioning apparatus of claim 2, wherein the one or more processors and one or more memories storing instructions are further operable, when executed by the one or more processors, to cause the tenant mapping and provisioning apparatus to:
determine, when a plurality of selected messaging system tenants have an authenticated association with the active incident management tenant, a correct selected messaging system tenant for transmission of the incident messaging data object.

7. The tenant mapping and provisioning apparatus of claim 1, wherein the one or more processors and one or more memories storing instructions are further operable, when executed by the one or more processors, to cause the tenant mapping and provisioning apparatus to:
receive, from an incoming event queue, event data;
cause, based at least in part on the event data, generation of an incident; and
generate an authenticated association between the incident and an incident management tenant.

8. A computer program product, the computer program product comprising at least one non-transitory computer-readable storage medium having computer-readable program code portions stored therein, the computer-readable program code portions configured to:
access an active incident management tenant of a multi-tenant incident management system, wherein the active incident management tenant is associated with an active user profile;
identify a candidate set of messaging system tenants of a multi-tenant messaging system, wherein the candidate set of messaging system tenants are each respectively associated with the active user profile;
generate an authenticated association between the active incident management tenant and a selected messaging system tenant of the candidate set of messaging system tenants, wherein the selected messaging system tenant defines at least one established authenticated association with another incident management tenant of the multi-tenant incident management system;
generate an incident messaging data object based on incident event data managed by the active incident management tenant; and
output the incident messaging data object to the selected messaging system tenant of the multi-tenant messaging system, wherein the incident messaging data object is configured to cause rendering of an incident event interface component to a messaging interface of the selected messaging system tenant of the multi-tenant messaging system, and wherein the incident event interface component is configured to enable triggering of one or more incident messaging actions associated with the incident event data through the messaging interface.

9. The computer program product of claim 8, wherein the computer-readable program code portions are further configured to:
receive, from the selected messaging system tenant of the multi-tenant messaging system, incident event data comprising an indication of an incident messaging action;
determine a correct incident management tenant of the multi-tenant incident management system for transmission of the incident event data;
output the incident event data to the correct incident management tenant of the multi-tenant incident management system;
receive, from the correct incident management tenant, updated incident event data comprising an indication of an incident update based on the incident messaging action;
generate an updated incident messaging data object based on the updated incident event data managed by the correct incident management tenant;
determine a correct selected messaging system tenant of the multi-tenant messaging system for transmission of the updated incident messaging data object; and
output the updated incident messaging data object to the correct selected messaging system tenant of the multi-tenant messaging system, wherein the updated incident messaging data object is configured to cause rendering of an incident event interface component to a messaging interface of the correct selected messaging system tenant of the multi-tenant messaging system.

10. The computer program product of claim 8, wherein the active incident management tenant has an authenticated association with a plurality of selected messaging system tenants.

11. The computer program product of claim 8, wherein the selected messaging system tenant has an authenticated association with a plurality of incident management tenants.

12. The computer program product of claim 8, wherein the computer-readable program code portions are further configured to:
request, prior to generation of the authenticated association between an active incident management tenant and a selected messaging system tenant, permission to access the selected messaging system tenant.

13. The computer program product of claim 9, wherein the computer-readable program code portions are further configured to:
determine, when a plurality of selected messaging system tenants have an authenticated association with the active incident management tenant, a correct selected messaging system tenant for transmission of the incident messaging data object.

14. The computer program product of claim 8, wherein the computer-readable program code portions are further configured to:
receive, from an incoming event queue, event data;
cause, based at least in part on the event data, generation of an incident; and
generate an authenticated association between the incident and an incident management tenant.

15. A computer-implemented method comprising:
accessing an active incident management tenant of a multi-tenant incident management system, wherein the active incident management tenant is associated with an active user profile;
identifying a candidate set of messaging system tenants of a multi-tenant messaging system, wherein the candidate set of messaging system tenants are each respectively associated with the active user profile;
generating an authenticated association between the active incident management tenant and a selected messaging system tenant of the candidate set of messaging system tenants, wherein the selected messaging system tenant defines at least one established authenticated association with another incident management tenant of the multi-tenant incident management system;
generating an incident messaging data object based on incident event data managed by the active incident management tenant; and
outputting the incident messaging data object to the selected messaging system tenant of the multi-tenant messaging system, wherein the incident messaging data object is configured to cause rendering of an incident event interface component to a messaging interface of the selected messaging system tenant of the multi-tenant messaging system, and wherein the incident event interface component is configured to enable triggering of one or more incident messaging actions associated with the incident event data through the messaging interface.

16. The computer-implemented method of claim 15, further comprising:
receiving, from the selected messaging system tenant of the multi-tenant messaging system, incident event data comprising an indication of an incident messaging action;
determining a correct incident management tenant of the multi-tenant incident management system for transmission of the incident event data;
outputting the incident event data to the correct incident management tenant of the multi-tenant incident management system;
receiving, from the correct incident management tenant, updated incident event data comprising an indication of an incident update based on the incident messaging action;
generating an updated incident messaging data object based on the updated incident event data managed by the correct incident management tenant;
determining a correct selected messaging system tenant of the multi-tenant messaging system for transmission of the updated incident messaging data object; and
outputting the updated incident messaging data object to the correct selected messaging system tenant of the multi-tenant messaging system, wherein the updated incident messaging data object is configured to cause rendering of an incident event interface component to a messaging interface of the correct selected messaging system tenant of the multi-tenant messaging system.

17. The computer-implemented method of claim 15, wherein the active incident management tenant has an authenticated association with a plurality of selected messaging system tenants.

18. The computer-implemented method of claim 15, wherein the selected messaging system tenant has an authenticated association with a plurality of incident management tenants.

19. The computer-implemented method of claim 15, further comprising:
requesting, prior to generation of the authenticated association between an active incident management tenant and a selected messaging system tenant, permission to access the selected messaging system tenant.

20. The computer-implemented method of claim 16, further comprising:
determine, when a plurality of selected messaging system tenants have an authenticated association with the active incident management tenant, a correct selected messaging system tenant for transmission of the incident messaging data object.
